(19) United States
(12) Patent Application Publication
(10) Pub. No.: US 2018/0258671 A1
(43) Pub. Date: Sep. 13, 2018

(54) AUXILIARY LOCKING DRIVE

(71) Applicant: Brose Schliesssysteme GmbH & Co. Kommanditgesellschaft, Wuppertal (DE)

(72) Inventors: Ludger Graute, Essen (DE); Axel Bettin, Hattingen (DE); Carsten Bruchsteiner, Witten (DE)

(21) Appl. No.: 15/919,872

(22) Filed: Mar. 13, 2018

(30) Foreign Application Priority Data
Mar. 13, 2017 (DE) 10 2017 105 284.4
Apr. 20, 2017 (DE) 10 2017 108 345.6

(51) Int. Cl. E05B 81/20; E05B 81/06; E05B 81/18; E05B 85/00; F16H 31/00; F16C 1/18; F16H 1/28

(52) U.S. Cl. CPC E05B 81/20; E05B 81/06; E05B 81/18; E05B 85/243; F16H 31/001; F16C 1/18; F16H 1/28; E05B 85/00

(57) ABSTRACT

The disclosure relates to an auxiliary locking drive for a motor vehicle lock, wherein the auxiliary locking drive, in the fitted state, provides an auxiliary locking drive train which has an auxiliary locking drive motor and a planetary gearing which is connected downstream of the auxiliary locking drive motor and has the following gearing elements: a sun gear, a planet gear carrier and a ring gear, wherein a first gearing element of the planetary gearing is coupled or is couplable to the auxiliary locking drive motor and a second gearing element of the planetary gearing is coupled or is couplable to the lock latch, wherein a switchable fixing device is provided, with which, for producing and releasing a drive coupling between the first gearing element and the second gearing element, the in each case third gearing element of the planetary gearing is fixable and releasable.

### CLAIM OF PRIORITY

This application claims the benefit of German Patent application No. DE 10 2017 105 284.4 filed on Mar. 13, 2017, and DE 10 2017 108 345.6 filed on Apr. 20, 2017, the disclosures of which are incorporated herein by reference.

### FIELD OF THE TECHNOLOGY

The disclosure relates to an auxiliary locking drive for a motor vehicle lock, to a motor vehicle lock with an auxiliary locking drive, to a motor vehicle lock arrangement with a motor vehicle lock and an auxiliary locking drive, and to a method for operating an auxiliary locking drive.

### BACKGROUND

The motor vehicle lock, to which the auxiliary locking drive under discussion is assigned, is used in all types of motor vehicle doors of a motor vehicle. The term “motor vehicle door” should be broadly interpreted here. It includes side doors, rear doors, tailgates, rear covers, engine hoods or the like. Such a motor vehicle door may be configured as a swivel door or as a sliding door.

The auxiliary locking drive under discussion serves for pulling the motor vehicle door shut by means of a motorized movement of the lock latch from its pre-locking position into its main locking position. For the locking, the operator here only has to bring the motor vehicle door with little effort into a pre-locking door position which corresponds to the pre-locking position of the lock latch. In the process, the auxiliary locking drive overcomes the comparatively high door sealing pressure, and therefore the locking operation of the motor vehicle door is designed to be particularly comfortable for the operator.

The known auxiliary locking drive (DE 10 2013 108 718 A1), on which the disclosure is based, provides an auxiliary locking drive train which has an auxiliary locking drive motor and a planetary gearing which is connected downstream of the auxiliary locking drive motor and has the following customary gearing elements: a sun gear, a planet gear carrier and a ring gear. For the motorized pulling of the motor vehicle door shut, an auxiliary locking operation is provided comprising an auxiliary locking adjustment of the second gearing element and a subsequent reversing adjustment of the second gearing element. The auxiliary locking adjustment is taken over here by a first drive, and the reversing adjustment by a second drive, of which at least one drive can also be configured to be spring-driven.

In the case of the known auxiliary locking drive, an alternate fixing of two gearing elements of the planetary gearing is required for the auxiliary locking adjustment, on the one hand, and the reversing adjustment, on the other hand. This leads to a comparatively complicated structural arrangement. Furthermore, the resulting noise behavior provides the potential for optimization, in particular with regard to the production of noise associated with the reversing adjustment.

### SUMMARY

The disclosure is based on the problem of configuring and developing the known auxiliary locking drive in such a manner that a low production of noise during the reversing adjustment can be achieved with little structural effort.

The above problem is solved in the case of an auxiliary locking drive according to the disclosure.

The basic consideration is essentially that the fixing and releasing of the third gearing element of the planetary gearing can be brought about by one and the same auxiliary locking drive motor if the fixing device required for this purpose is correspondingly coupled or couplable to the auxiliary locking drive train. The reversing adjustment of the second gearing element back into the starting position can then be performed in a manner decoupled from the auxiliary locking drive motor, in particular in a spring-driven manner.

In detail, according to the proposal, the arrangement has been made in such a manner that, within the scope of the auxiliary locking operation after the auxiliary locking adjustment, the fixing device is released by means of the auxiliary locking drive motor, and therefore a subsequent, in particular spring-driven, reversing adjustment of the second gearing element back into the starting state has been decoupled from the auxiliary locking drive motor.

With the solution according to the proposal, it is possible, in the first place, to fix and to release the third gearing element of the planetary gearing without an additional drive motor being required. This simplifies the structural effort. At the same time, with the solution according to the proposal, a spring-driven reversing adjustment of the second gearing element can be readily produced, which, in turn with little structural effort, permits rapid and therefore noise-reduced reversing adjustment of the second gearing element. The associated spring arrangement can be tensioned here during the auxiliary locking adjustment of the second gearing element.

According to the proposal, the release according to the proposal of the fixing device takes place after the auxiliary locking adjustment, and therefore the pulling of the door shut is not impaired by the release. However, it can basically be provided that the release operation starts already during the auxiliary locking adjustment without release of the fixing device already occurring.

Some embodiments permit release of the fixing device, the release managing without blocking the auxiliary locking drive motor. The release of the fixing device is therefore attributed to an adjustment of the auxiliary locking drive motor, for the ending of which adjustment the blocking of the auxiliary locking drive motor is not envisaged. In some cases it can be provided that the auxiliary locking drive motor is adjusted in a time- or distance-controlled manner, and therefore blocking of the auxiliary locking drive motor can be dispensed with. Of particular advantage here is the fact that the omission of the blocking mode, i.e. the blocking of the auxiliary locking drive motor, is associated with a particularly low production of noise. Furthermore, the mechanical loading of the components involved in the release of the fixing device is reduced since no blocking forces occur.

Various embodiments relate to the drive coupling between the auxiliary locking drive train and the fixing device in order to release the fixing device in a motorized manner within the scope of a release adjustment. For this purpose, the auxiliary locking drive train has an engagement component, which can be an intermediate gearing element which is arranged between the auxiliary locking drive motor and the planetary gearing. In other variants, however, the engagement component may also be a motor shaft of the auxiliary locking drive motor or one of the gearing elements of the planetary gearing.

An embodiment relates to a possibility for blocking-free release of the fixing device in such a manner that the engagement component is correspondingly configured in a blocking-free manner at least for the release adjustment of the second gearing element. According to some embodiments, the corresponding is provided for the intermediate gearing element.

Various embodiments relate to structural variants for the fixing device. The equipping of the fixing device with a fixing element which interacts with the third gearing element of the planetary gearing in the manner of a ratchet has proven particularly robust mechanically. All that is then needed for the release of the fixing device is ejection of the fixing element, which does not provide any difficulties structurally.

Various embodiments relate to structural variants for the adjustment of the fixing element of the fixing device by means of the auxiliary locking drive motor. It is provided here that, in a first adjustment direction, the engagement component leaves the state of the fixing element unaffected, and, in a second adjustment direction opposite the first adjustment direction, adjusts the fixing element into the release state. It can therefore be ensured that, during the auxiliary locking adjustment, i.e. during the pulling of the motor vehicle door shut, the fixing element is unaffected by the engagement component. After the auxiliary locking adjustment, the auxiliary locking drive motor can be reversed, and therefore the engagement component adjusts the fixing element in the second adjustment direction into the release state. The release adjustment, in which the fixing device is released, can be part of the reversing adjustment, but forms only a small part of the reversing adjustment. In the case of the spring-driven reversing adjustment, this means that, after the release of the fixing device, the reversing adjustment is completely performed in a spring-driven manner.

A particularly simple refinement of the fixing device is disclosed, in which the control element there is configured as a wire or strip bendable spring-elastically. By means of the bendability, a particularly simple connection of the control element to the fixing device arises without a joint between control element and fixing device being necessary.

Furthermore, the configuration of the control element as a wire or strip which is bendable spring-elastically is advantageous since the spring elasticity of the control element itself can be used in order to produce spring prestressing of the control element. This results in a dual use of the control element, which leads to a cost-effective and compact configuration.

According to some embodiments, a motor vehicle lock as such is disclosed, to which an auxiliary locking drive according to the proposal is assigned. In this respect, reference may be made to all of the embodiments regarding the auxiliary locking drive according to the proposal.

A common housing can be assigned to the motor vehicle lock and to the auxiliary locking drive, thus resulting in a standardized assembly. This can be advantageous in particular in terms of production.

According to some embodiments, a motor vehicle lock arrangement is disclosed which has a motor vehicle lock and an auxiliary locking drive according to the proposal, wherein the motor vehicle lock and the auxiliary locking drive are configured separately from each other and are arranged separated spatially from each other. Also in this respect, reference may be made to all of the embodiments regarding the auxiliary locking drive according to the proposal.

In an embodiment, the motor vehicle lock, in particular the lock latch of the motor vehicle lock, and the auxiliary locking drive, in particular the second gearing element of the planetary gearing, are coupled to each other in terms of drive by means of a flexible force transmission means, in particular by means of a Bowden cable.

According to a further teaching according to some embodiments, a method for operating an auxiliary locking drive according to the proposal, for operating a motor vehicle lock according to the proposal or for operating a motor vehicle lock arrangement according to the proposal is disclosed.

According to the method according to the proposal, it is essential that, within the scope of the auxiliary locking operation after the auxiliary locking adjustment, the fixing device is released by means of the auxiliary locking drive motor, and therefore a subsequent reversing adjustment back into the starting state can be performed in a manner decoupled from the auxiliary locking drive motor.

Of particular significance for the method according to the proposal, as explained in conjunction with the auxiliary locking drive according to the proposal, is that the auxiliary locking drive motor is used not only for the auxiliary locking adjustment, but also for release of the fixing device. Also to this extent, reference may be made to all of the embodiments regarding the auxiliary locking drive according to the proposal.

In some embodiments, a particularly reduced production of noise arises by the fact that the auxiliary locking drive motor is adjusted in a blocking-free manner in order to release the fixing device. Reference may be made to the above embodiments regarding the blocking-free adjustment of the auxiliary locking drive motor.

An embodiment provides an auxiliary locking drive for a motor vehicle lock which has the following locking elements: a lock latch and a pawl, wherein the auxiliary locking drive, in the fitted state, provides an auxiliary locking drive train which has an auxiliary locking drive motor and a planetary gearing which is connected downstream of the auxiliary locking drive motor and has the following gearing elements: a sun gear, a planet gear carrier and a ring gear, wherein a first gearing element of the planetary gearing is coupled or is couplable to the auxiliary locking drive motor and a second gearing element of the planetary gearing is coupled or is couplable to the lock latch, wherein, within the scope of an auxiliary locking operation, the lock latch is adjustable in the locking direction thereof by means of the auxiliary locking drive motor by the second gearing element performing an auxiliary locking adjustment from a starting state, wherein a switchable fixing device is provided, with which, in order to produce and release a drive coupling between the first gearing element and the second gearing element, the in each case third gearing element of the planetary gearing is fixable and releasable, wherein the arrangement has been made in such a manner that, within the scope of the auxiliary locking operation after the auxiliary locking adjustment, the fixing device is released by means of the auxiliary locking drive motor, and therefore a subsequent, in particular spring-driven, reversing adjustment of the second gearing element back into the starting state has been decoupled from the auxiliary locking drive motor.

In some embodiments, in the fitted state, the auxiliary locking adjustment of the auxiliary locking drive train brings about an adjustment of the lock latch in the locking direction thereof, in particular from a pre-locking position into a main locking position or into an overtravel position located on the other side of the main locking position.

In some embodiments, a control arrangement is provided which electrically activates the auxiliary locking drive motor within the scope of the auxiliary locking operation.

In some embodiments, the arrangement has been made in such a manner that the release of the fixing device is associated with a blocking-free adjustment of the auxiliary locking drive motor.

In some embodiments, the control arrangement adjusts the auxiliary locking drive motor in a time- or distance-controlled manner in order to release the fixing device.

In some embodiments, after the release of the fixing device, the reversing adjustment takes place in a spring-driven manner, such as wherein, in order to produce the spring-driven reversing adjustment, a resetting spring arrangement is provided, furthermore wherein the resetting spring arrangement is coupled or is couplable to the first or second gearing element of the planetary gearing.

In some embodiments, the auxiliary locking operation comprises a release adjustment of the second gearing element by means of the auxiliary locking drive motor, within the scope of which release adjustment an adjustable engagement component of the auxiliary locking drive train comes into engagement with the fixing device, releasing the latter, such as wherein the release adjustment comprises a starting adjustment distance which is passed through before the release of the fixing device, such as wherein the release adjustment is opposed to the auxiliary locking adjustment.

In some embodiments, an intermediate gearing element which provides the engagement component is arranged in the auxiliary locking drive train between the auxiliary locking drive motor and the planetary gearing.

In some embodiments, the engagement component is adjusted in a blocking-free manner at least for the release adjustment of the second gearing element.

In some embodiments, the intermediate gearing element is configured to be endlessly adjusting, in particular endlessly rotating, in a blocking-free manner.

In some embodiments, the fixing device has a fixing element, in particular a fixing lever, which fixing element or fixing lever is adjustable between a fixing state, in which said fixing element or fixing lever fixes the third gearing element, and a release state, in which said fixing element or fixing lever releases the third gearing element, such as wherein the fixing element, which is in the fixing state, and the third gearing element of the planetary gearing are in fixing engagement with each other in a form-fitting and/or force-fitting manner.

In some embodiments, the third gearing element has at least one latching formation with which the fixing element in the fixing state is in form-fitting engagement, such as wherein the third gearing element has a plurality of latching formations, and wherein the fixing element in the fixing state is in form-fitting engagement with one of the latching formations, furthermore wherein the fixing element and the third gearing element interact with each other in the manner of a ratchet.

In some embodiments, the fixing element is configured as a wrap spring, and wherein the fixing element in the fixing state is in braking engagement with the third gearing element for the fixing of the third gearing element.

In some embodiments, the engagement component has a first control contour via which the fixing element is adjustable.

In some embodiments, a freewheeling mechanism is connected between the engagement component and the fixing element in such a manner that, in a first adjustment direction, the engagement component leaves the state of the fixing element unaffected, and, in a second adjustment direction opposed to the first adjustment direction, adjusts the fixing element into the release state.

In some embodiments, the freewheeling mechanism has a control element, in particular a control lever, which, in the first adjustment direction of the engagement component, is disengaged from the first control contour and, in the second adjustment direction, is in engagement or comes into engagement with the first control contour and which thereby adjusts the fixing element into the release state.

In some embodiments, the engagement component has a second control contour which controls the control element in the first adjustment direction of the engagement component in a manner disengaged from the first control contour.

In some embodiments, the engagement component is adjustable in a blocking-free manner in the first adjustment direction.

In some embodiments, the control element is configured as a wire or strip which is bendable spring-elastically and, for the release of the fixing arrangement, can be brought into engagement with the fixing arrangement, in particular with the fixing element.

In some embodiments, the control element is prestressed onto the engagement component, in particular onto the first control contour, such as wherein the prestressing of the control element is attributed to the spring elasticity of the control element itself, such as wherein the spring elasticity of the control element also produces a prestressing of the fixing element into the fixing state.

An embodiment provides motor vehicle lock with an auxiliary locking drive as described herein.

In some embodiments, the motor vehicle lock and the auxiliary locking drive are configured separately from each other and are arranged separated spatially from each other.

An embodiment provides a method for operating an auxiliary locking drive as described herein wherein within the scope of the auxiliary locking operation after the auxiliary locking adjustment, the fixing device is released by means of the auxiliary locking drive motor, and therefore a subsequent, in particular spring-driven, reversing adjustment of the second gearing element back into the starting state has been decoupled from the auxiliary locking drive motor.

In some embodiments, the auxiliary locking drive motor is adjusted in a time- or distance-controlled manner in order to release the fixing device.

In some embodiments, the auxiliary locking drive motor is adjusted in a blocking-free manner in order to release the fixing device.

### BRIEF DESCRIPTION OF THE DRAWINGS

The disclosure is explained in more detail below with reference to drawings which merely illustrate exemplary embodiments. In the drawings,

FIG. 1 shows a motor vehicle door with a motor vehicle lock arrangement according to the proposal, which has a motor vehicle lock according to the proposal and an auxiliary locking drive according to the proposal,

FIG. 2 shows the auxiliary locking drive according to FIG. 1 in the starting state, in a perspective view,

FIG. 3 shows the auxiliary locking drive according to FIG. 1 during the auxiliary locking adjustment,

FIG. 4 shows the auxiliary locking drive according to FIG. 1 during the reversing adjustment,

FIG. 5 shows a further embodiment of the auxiliary locking drive according to FIG. 1 in the starting state, in a perspective view,

FIG. 6 shows the auxiliary locking drive according to FIG. 5 during the auxiliary locking adjustment, and

FIG. 7 shows the auxiliary locking drive according to FIG. 6 during the reversing adjustment.

### DETAILED DESCRIPTION

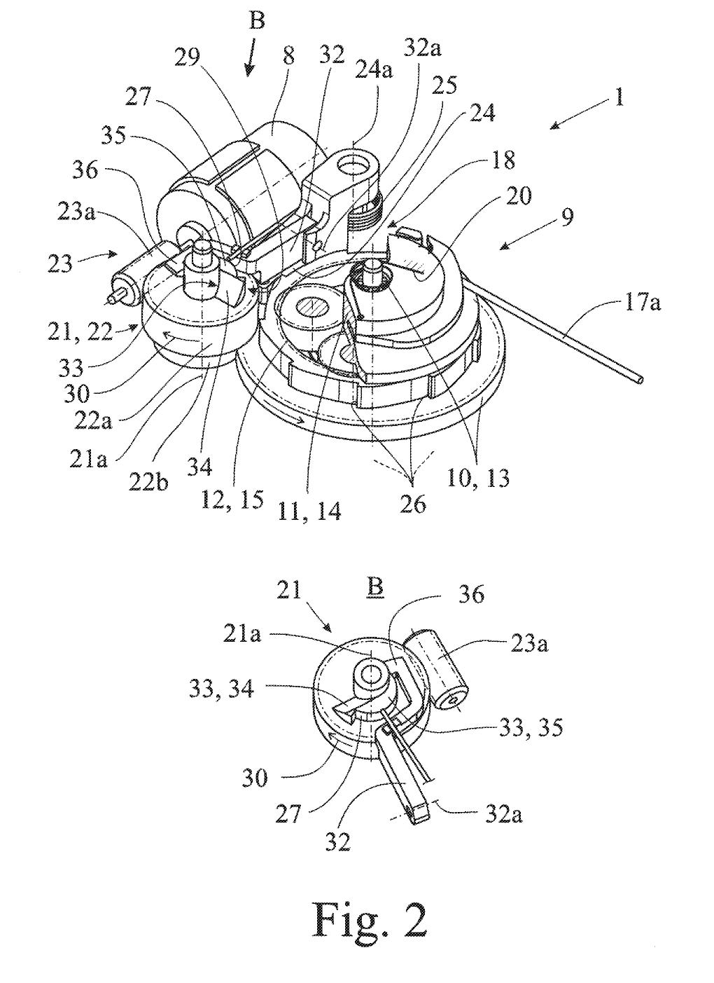

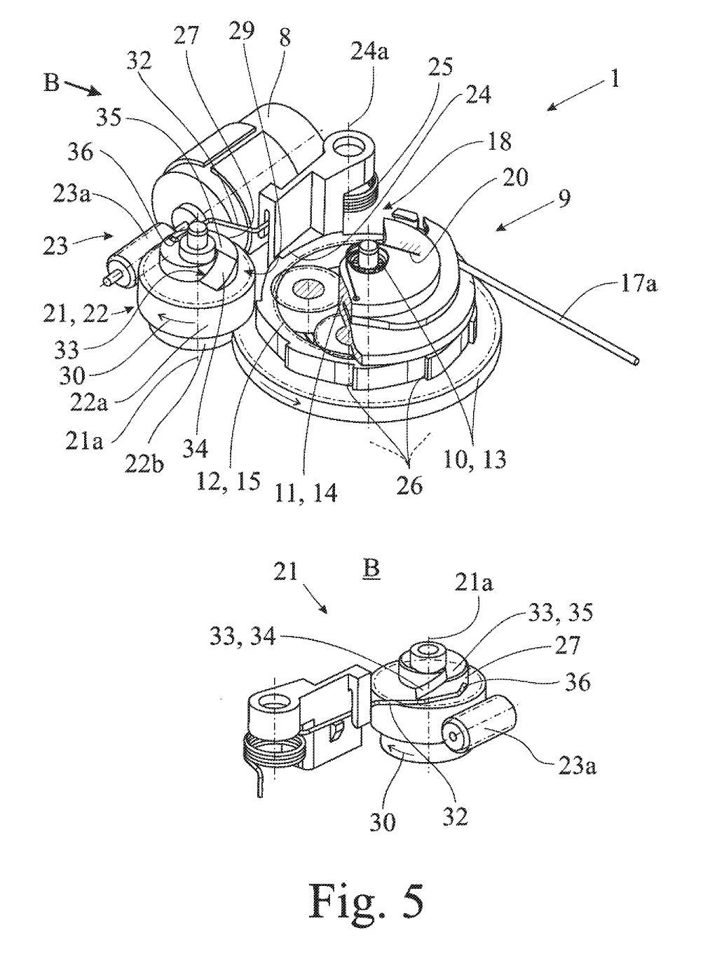

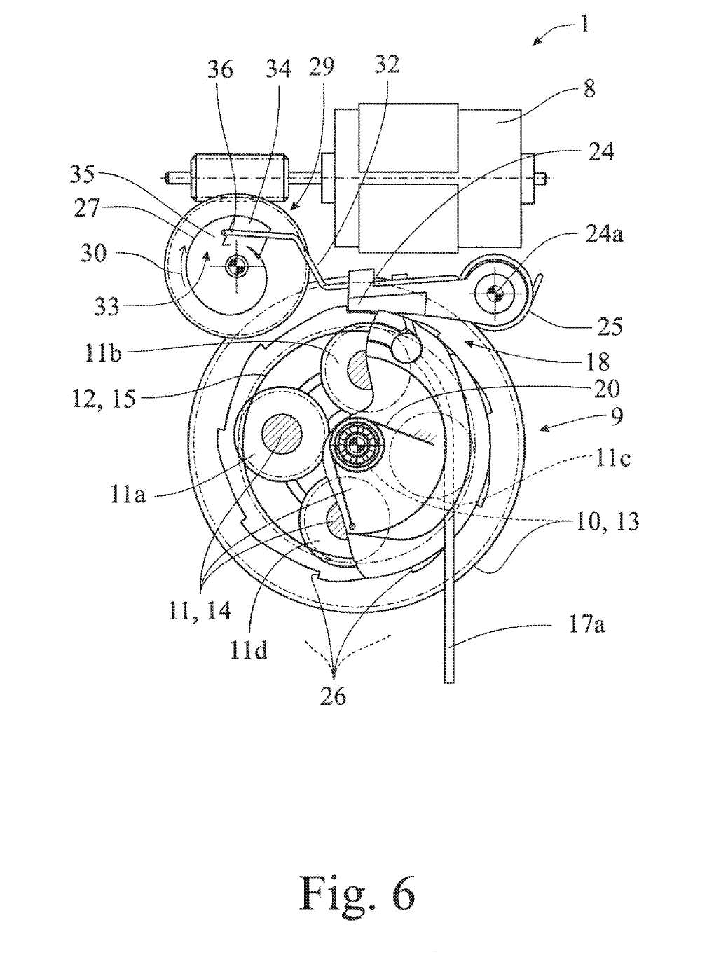

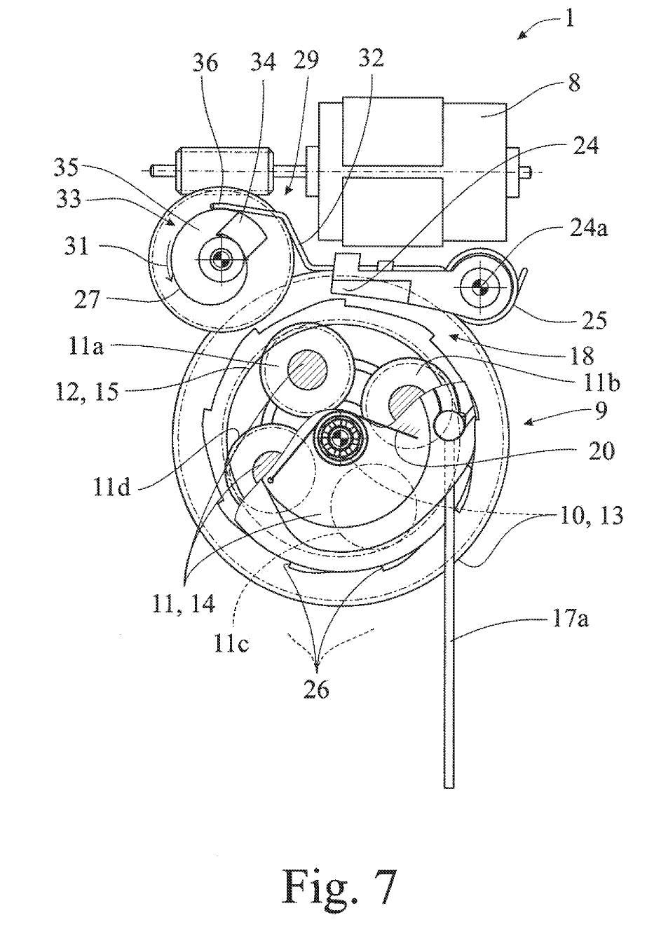

FIGS. 2 to 4 relate to a first embodiment of the auxiliary locking drive 1 according to the proposal, while FIGS. 5 to 7 relate to a second embodiment of the auxiliary locking drive according to the proposal. In terms of basic construction, the two embodiments are identical, and therefore the statements below regarding the first embodiment apply correspondingly to the second embodiment. Components of identical function have been provided with identical reference signs in FIGS. 2 to 4 and in FIGS. 5 to 7.

The auxiliary locking drive 1 according to the proposal is assigned to a motor vehicle lock 2 which, in turn, is assigned to a motor vehicle door 3. The motor vehicle door 3 can be a side door, a rear door, a tailgate, a rear cover, an engine hood or the like. It may be configured as a swivel door or as a sliding door.

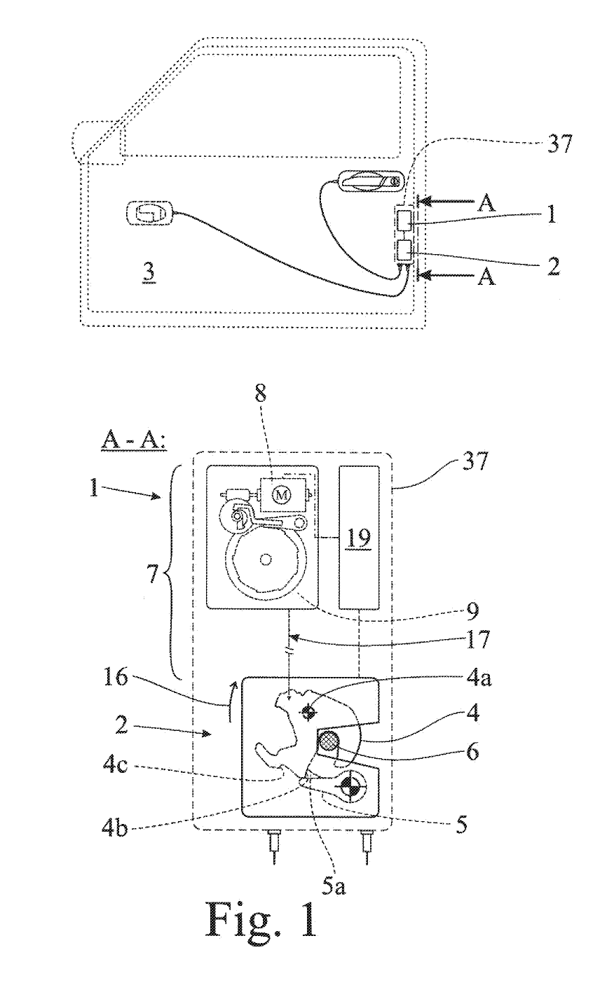

The motor vehicle lock 2 has the following locking elements: a lock latch 4 and a pawl 5. The lock latch 4 can be pivoted from an open position (not illustrated) about a lock latch axis 4a into a main locking position, illustrated in FIG. 1. A pre-locking position is located between the open position and the main locking position. Both in the main locking position and in the pre-locking position, the lock latch 4 is engaged in a holding manner with a locking part 6. In the open position, the lock latch 4 releases the locking part 6. In the main locking position and in the pre-locking position, the lock latch 4 is blocked by the pawl 5 against pivoting in the opening direction. For this purpose, the pawl 5 has a blocking lug 5a which, in the main locking position, is in blocking engagement with a main catch 4b and, in the pre-locking position, with a preliminary catch 4c of the lock latch 4.

The locking part 6 here is a locking bolt. Alternatively, however, the locking part 6 may also be a locking clip or the like.

In order to be able to adjust the lock latch 4 in a motorized manner from the pre-locking position into the main locking position, the auxiliary locking drive 1, in the fitted state, provides an auxiliary locking drive train 7 which has an auxiliary locking drive motor 8 and a planetary gearing 9 which is connected downstream of the auxiliary locking drive motor 8 and has the following customary gearing elements: a sun gear 10, a planet gear carrier 11 with planet gears 11a, 11b, 11c, 11d and a ring gear 12. A first gearing element 13 of the planetary gear 9, here the sun gear 10, is coupled to the auxiliary locking drive motor 8, while a second gearing element 14, here the planetary gear carrier 11, is coupled or is couplable to the lock latch 4. The third gearing element 15 is correspondingly the ring gear 12 here. This assignment between the first, second and third gearing elements 13, 14, 15, on the one hand, and sun gear 10, planet gear carrier 11 and ring gear 12, on the other hand, may also be provided differently.

Within the scope of an auxiliary locking operation, the lock latch 4 is adjustable in its locking direction 16 by means of the auxiliary locking drive motor 8 by the second gearing element 14 performing an auxiliary locking adjustment from the starting state shown in FIG. 2. From the starting state illustrated in FIG. 2, the auxiliary locking adjustment ensures that the second gearing element 14, here the planet gear carrier 11, is adjusted counterclockwise in FIG. 2, and therefore the core 17a of the Bowden cable 17, which connects the auxiliary locking drive 1 to the motor vehicle lock 2, is retracted by the auxiliary locking drive 1. This leads in turn to pivoting of the lock latch 4 in the clockwise direction in FIG. 1, which corresponds to the locking direction 16 of the lock latch 4.

For the production and release of the drive coupling, which is required for the auxiliary locking adjustment, between the first gearing element 13 and the second gearing element 14, the in each case third gearing element 15 of the planetary gearing 9 is fixable. For this purpose, a switchable fixing device 18 is provided, with which the third gearing element 15 is not only fixable, but it is also releasable. In the present case, the term “fixable” means that the third gearing element 15 is not rotatable. For example, the third gearing element 15 in the fixed state is secured to a housing or the like of the auxiliary locking drive 1. The fixing device can act here directly on the third gearing element or can act indirectly on the third gearing element, optionally via an intermediate gearing element.

It is now essential that the arrangement has been made in such a manner that, within the scope of the auxiliary locking operation after the auxiliary locking adjustment, the fixing device 18 is released by means of the auxiliary locking drive motor 8, and therefore a subsequent, in particular spring-driven, reversing adjustment back into the starting state has been decoupled from the auxiliary locking drive motor 8. An interaction between the auxiliary locking drive train 7 and the fixing device 18 is therefore provided in such a manner that the fixing device 18 is releasable by means of the auxiliary locking drive motor 8. Said interaction can be provided here between a gearing stage connected downstream of the auxiliary locking drive motor 8 and the fixing device 18.

With the motorized release of the fixing device 18, the auxiliary locking drive motor 8 releases the lock latch 4 to a certain extent, and therefore the reversing adjustment can be undertaken in a spring-driven manner, decoupled from the auxiliary locking drive motor 8. A particularly rapid and therefore noise-optimized reversing adjustment can therefore be realized with just one auxiliary locking drive motor 8.

By means of the rapid reversing adjustment, it is furthermore possible to open the motor vehicle door 3 again virtually immediately after the motorized pulling shut since long waiting times in relation to the end of the reversing adjustment are omitted.

Here, the drive coupling between the auxiliary locking drive motor 8 and the first gearing element 13 of the planetary gearing is configured to be self-locking. This means that, during the reversing adjustment, resetting of the auxiliary locking drive motor 8 is blocked.

As discussed above, in the fitted state, the auxiliary locking adjustment of the second gearing element 14 brings about an adjustment of the lock latch 4 in the locking direction 16 thereof. In principle, it can be provided that the auxiliary locking adjustment of the second gearing element 14 brings about an adjustment of the lock latch 4 from the pre-locking position into the main locking position. However, here, it is the case that the auxiliary locking adjustment of the second gearing element 14 brings about an adjustment of the lock latch 4 from the pre-locking position into an overtravel position located on the other side of the main locking position, and therefore the pawl 5 can reliably drop into the main catch 4b in a spring-driven manner.

In the exemplary embodiments which are illustrated, an electric control arrangement 19 is provided which electrically activates the auxiliary locking drive motor 8 within the scope of the auxiliary locking operation.

In principle, the fixing device 18 can be released in the blocking mode, which is yet to be explained, as is provided in FIGS. 2 to 4. By contrast, in the exemplary embodiment shown in FIGS. 5 to 7, the arrangement has been made in such a manner that the release of the fixing device 18 is associated with a blocking-free adjustment of the auxiliary locking drive motor 8. It is here the case that the control arrangement 19 adjusts the auxiliary locking drive motor 8 in a time- or distance-controlled manner in order to release the fixing device 18. This is explained in more detail further below in conjunction with the method according to the proposal.

After the auxiliary locking adjustment and the release of the fixing device 18, the reversing adjustment can be undertaken in a spring-driven manner. For the production of the spring-driven reversing adjustment of the second gearing element 14, a resetting spring arrangement 20 can be provided. In the exemplary embodiments which are illustrated in the drawing, the resetting spring arrangement 20 is coupled or is couplable to the second gearing element 14, i.e. here to the planet gear carrier 11.

The resetting spring arrangement 20 can basically also be arranged in the motor vehicle lock 2. The resetting spring arrangement 20 is therefore coupled or couplable to the lock-latch-side end of the core 17a of the Bowden cable 17.

The spring-driven reversing adjustment of the second gearing element 14 is advantageous as an exact activation of the auxiliary locking drive motor 8 is not required for the reversing adjustment. Positional control of the auxiliary locking drive motor 8, for example by a blocking mode, can be dispensed with for the reversing adjustment.

It is very generally provided that the auxiliary locking operation comprises a release adjustment of the second gearing element 14 by means of the auxiliary locking drive motor 8, within the scope of which an adjustable engagement component 21 of the auxiliary locking drive train 7 comes into engagement with the fixing device 18, releasing the latter. The engagement component 21, which is yet to be explained, is pivotable here about an engagement component axis 21a. In a manner yet to be explained, the release adjustment of the second gearing element 14 can comprise a starting adjustment distance which is passed through before the release of the fixing device 18. For the case in which the release adjustment is opposed to the auxiliary locking adjustment, the starting adjustment distance brings about a certain relaxation of the auxiliary locking drive train 7. This is advantageous insofar as the release of the fixing device 18 does not take place under full load, which is advantageous against the background of the objective of little production of noise.

It can be gathered from the illustrations in the drawing that an intermediate gearing element 22 which provides the engagement component 21 is arranged in the auxiliary locking drive train 7 between the auxiliary locking drive motor 8 and the planetary gearing 9. The intermediate gearing element 22 has two spur gear toothings 22a, 22b which mesh with the motor shaft 23, here with the worm 23a of the motor shaft 23, on the one hand, and the sun gear 10 of the planetary gearing 9, on the other hand.

In principle, however, the engagement component 21 may also be the motor shaft 23 of the auxiliary locking drive motor 8 or the first or second gearing element 13, 14 of the planetary gearing 9.

Very generally, the release adjustment of the second gearing element 14 can be provided in the locking mode. In the exemplary embodiment of FIGS. 2 to 4, this is provided by the realization of a blocking contour 28 which is yet to be explained.

By contrast, in the exemplary embodiment shown in FIGS. 5 to 7, it is provided that the engagement component 21 is adjusted in a blocking-free manner at least for the release adjustment of the second gearing element 14, as discussed above. Correspondingly, a blocking contour 28 is not provided here. On the contrary, it is the case here that the intermediate gearing element 22 is configured to be endlessly adjusting, in particular endlessly rotating, in a blocking-free manner.

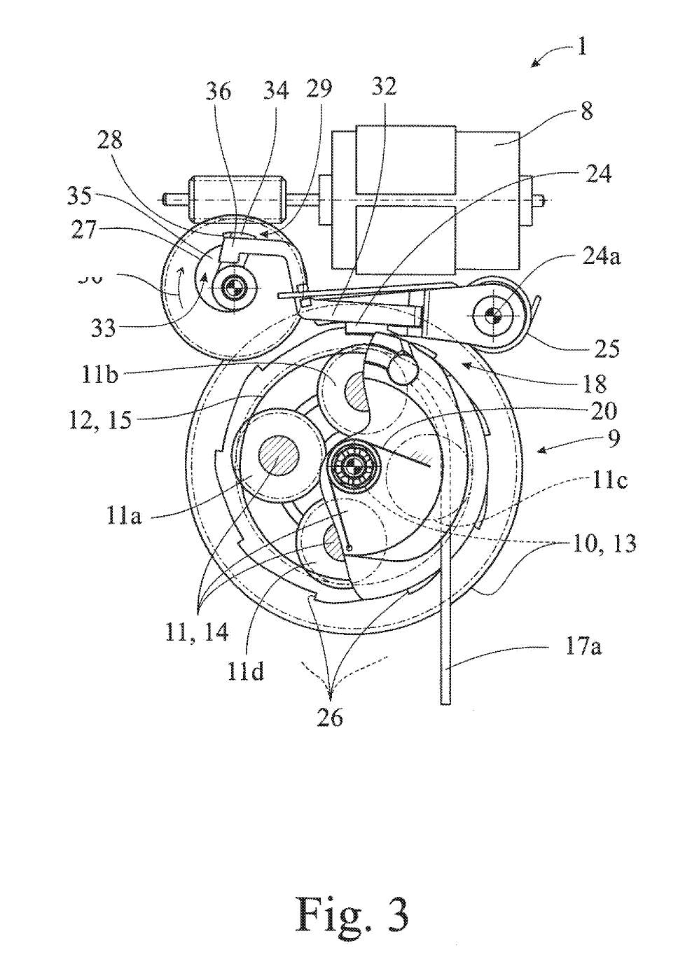

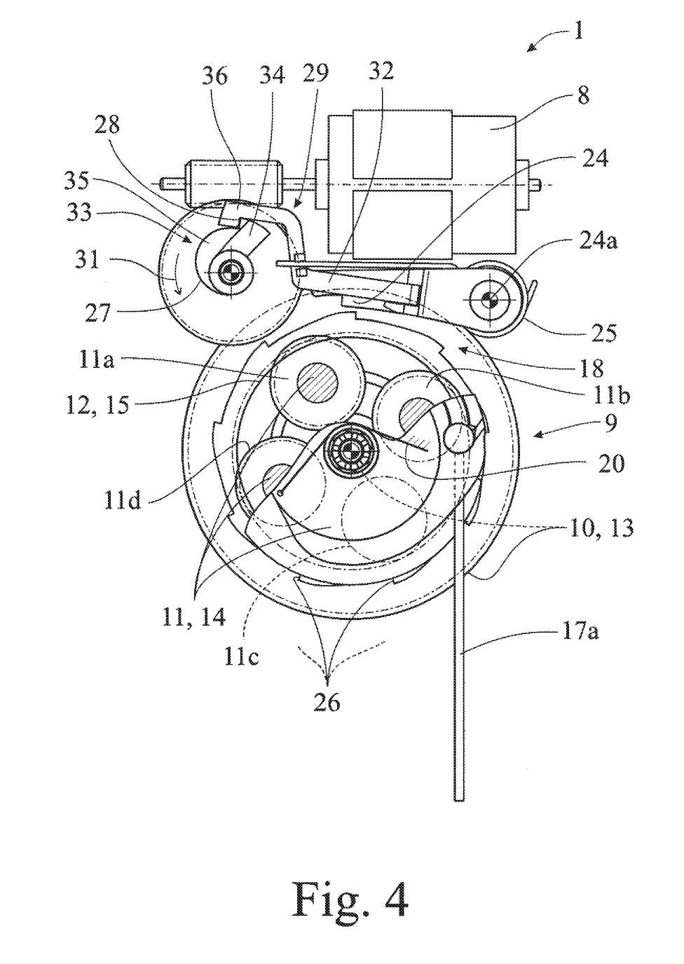

The structurally simple configuration of the fixing device 18 obtains particular significance here. The fixing device 18 correspondingly has a fixing element 24 which is adjustable between a fixing state, which is shown in FIGS. 2 and 3 and in which it fixes the third gearing element 15, and a release state, which is shown in FIG. 4 and in which it releases the third gearing element 15. The fixing element 24 here is a fixing lever which is pivotable about a fixing element axis 24a. The fixing element 24 is prestressed here into the fixing state, in the counterclockwise direction of FIGS. 2 to 4, by means of a fixing element spring 25.

In the fixing state of the fixing element 24, it is the case that the fixing element 24 and the third gearing element 15 of the planetary gearing 9 are in engagement with each other in a form-fitting and/or force-fitting manner in order to fix the third gearing element 15. In the exemplary embodiments illustrated in the drawing, the fixing engagement between the fixing element 24 and the third gearing element 15 is primarily a form-fitting engagement. For this purpose, the third gearing element 15, here the ring gear 12, has at least one latching formation 26 with which the fixing element 24 in the fixing state is in form-fitting engagement. Here, it is the case that the third gearing element 15 has a plurality of latching formations 26 which are arranged distributed over a circumference of the third gearing element 15, wherein the fixing element 24 in the fixing state is in form-fitting engagement with one of the latching formations 26. It can be gathered from the illustrations according to FIGS. 2 to 4 that the fixing element 24 and the third gearing element 15 interact with each other in the manner of a ratchet.

Alternatively, however, a braking engagement between the fixing element 24 and the third gearing element 15 can also be provided. Of advantage here is the fact that the braking of the third gearing element 15 is then possible in every position of the third gearing element 15. A possibility, but which is not illustrated here, for the braking of the third gearing element 15 consists in that the fixing element 24 is configured as a wrap spring, wherein the fixing element 24 in the fixing state is in braking engagement with the third gearing element 15 for the fixing of the third gearing element 15. It can be the case here that the wrap spring surrounds a circumference of the third gearing element 15 or a circumference of a component which is coupled to the third gearing element 15. It is in each case the case here that one end of the wrap spring can be brought into engagement with the above-discussed engagement component 21 in order to release the wrap spring from the third gearing element 15.

In the exemplary embodiments which are illustrated, the adjustment of the fixing element 24, in particular the adjustment of the fixing element 24 into the release state, is also achieved in a particularly simple manner. The engagement component 21 here has a first control contour 27 via which the fixing element 24 is adjustable. The first control contour 27 is provided with a radial control surface which is oriented substantially parallel to the engagement element axis 21a. A blocking contour 28, which is explained further below, is found at one end of the first control contour 27.

In order to avoid the fixing device 18 being released inadvertently during the auxiliary locking adjustment, a freewheeling mechanism 29 is connected between the engagement component 21 and the fixing element 24 in such a manner that, in a first adjustment direction 30, the engagement component 21 leaves the state of the fixing element 24 unaffected, and, in a second adjustment direction 31 opposed to the first adjustment direction 30, adjusts the fixing element 24 into the release state.

The freewheeling mechanism 29 here has a control element 32, in particular a control lever 32, which, in the first adjustment direction 30 of the engagement component 21, is disengaged from the first control contour 27 and, in the second adjustment direction 31, is in engagement or comes into engagement with the first control contour 27 and which thereby adjusts the fixing element 24 into the release state. The control lever 32 is arranged on the fixing element 24 so as to be pivotable about the control lever axis 32a.

Furthermore, it can be the case that the engagement component 21 has a second control contour 33 which controls the control lever 32 in the first adjustment direction 30 of the engagement component 21 in a manner disengaged from the first control contour 27. The second control contour 33 is provided here and with a control surface which is oriented substantially transversely with respect to the engagement component axis 21a. This detail of the orientation of the control surface of the second control contour 33 should be interpreted broadly since a run-on slope 34 which is yet to be explained should also be understood by this.

An auxiliary locking operation proceeds in the case of the auxiliary locking drive 1 according to the proposal as follows:

From the starting state shown in FIG. 1, the auxiliary locking drive motor 8 is electrically activated by the control arrangement 19 in such a manner that the engagement element 21 is adjusted in its first adjustment direction 30, in the clockwise direction in FIGS. 2 and 3. As a result, the first gearing element 13, here the sun gear 10, is adjusted in the counterclockwise direction, and therefore the planet gear carrier 11 is adjusted in the counterclockwise direction in FIGS. 2 and 3. The lock latch 4 is thereby adjusted in its locking direction 16, in the clockwise direction in FIG. 1, via the Bowden cable 17 such that said lock latch, starting from the pre-locking position, reaches its main locking position and optionally an overtravel position positioned on the other side of the main locking position. The pawl 5 can thereby drop into the main catch 4b in a spring-driven manner. During this auxiliary locking adjustment, the engagement component 21 is rotated here and in some embodiments several times. In the process, a sensing portion 36 of the control lever 32 slides along the engagement component 21 and reaches the run-on slope 34 of the second control contour 33. The control lever 32 is thereby raised and thus pivots about its control lever axis 32a which is oriented transversely with respect to the fixing element axis 24a of the fixing element 24. Subsequently, the sensing portion 36 of the control lever 32 slides on a plateau 35 which adjoins the run-on slope 34. The sensing portion 36 thus slides to a certain extent past the first control contour 27 without bringing about a deflection of the fixing element 24 about the fixing element axis 24a. Subsequently, the control lever 32 drops again onto the engagement component 21. This in turn effects the fixing element spring 25 which not only prestresses the fixing element 24 into the fixing state, but also prestresses the control lever 32 downward in FIG. 2. This sequence is repeated during each rotation of the engagement component 21. As a result, the complete auxiliary locking adjustment can be performed without the state of the fixing element 24 changing. This corresponds to the transition from FIG. 2 to FIG. 3.

In the situation shown in FIG. 3, the lock latch 4 now runs into its overtravel position, wherein the auxiliary locking drive motor 8 is stopped by means of the control arrangement 19 when the overtravel position is reached. This can be provided in a sensor- or time-controlled manner. Subsequently, the control arrangement 19 controls the auxiliary locking drive motor 8 in the opposite drive direction in such a manner that the engagement component 21 rotates in the adjustment direction 31. From the situation shown in FIG. 3, this has the effect that the sensing portion 36 of the control lever 32 slides downward on the run-on slope 34 and subsequently comes into engagement with the radial control surface of the first control contour 27, and therefore the first control contour 27 presses the fixing element 24 via the control lever 32 into the release state, as can be gathered from the illustration according to FIG. 4. When the sensing portion 36 is located at the end of the first control contour 27, the sensing portion 36 comes into engagement with a blocking contour 28 of the first control contour 27, and therefore further adjustment of the auxiliary locking drive motor 8 is stopped. Directly after release of the third gearing element 15 from the fixing element 24, the third gearing element 15, driven by the resetting spring arrangement 20 and decoupled from the auxiliary locking drive motor 8, snaps into the starting state. This is indicated in FIG. 4.

It is now conceivable for the auxiliary locking drive motor 8 and the engagement component 21 to remain in the position illustrated in FIG. 4 until the next auxiliary locking operation is started. Alternatively, it can be provided that the auxiliary locking drive motor 8 and the engagement component 21 are adjusted into the position illustrated in FIG. 2, and therefore, during the next auxiliary locking operation, the release of the fixing element 24 from the engagement component 21 does not have to be waited for.

In the exemplary embodiment illustrated in FIGS. 5 to 7, the locking operation basically proceeds as explained above, wherein the engagement component 21 is, however, adjustable in a blocking-free manner in the first adjustment direction 30. The first control contour 27 is correspondingly provided without a blocking contour 28 shown in FIGS. 2 to 4.

In the exemplary embodiment illustrated in FIGS. 5 to 7, it is furthermore the case that the control element 32 is configured as a wire or strip which is bendable spring-elastically and can be brought into engagement with the fixing arrangement 18, in particular with the fixing element 24, in order to release the fixing arrangement 18.

The control element 32 shown in FIGS. 5 to 7 can be configured as a wire with a round cross section. Other cross sections are conceivable. For the situation in which the control element is configured as a strip which is bendable spring-elastically, the cross section can be a rectangular cross section.

The control element 32 which is shown in FIGS. 5 to 7 and is configured as a spring-elastic wire or strip can be formed from a metallic material, in particular from a spring wire. In principle, however, a plastics material can also be used here.

In the case last mentioned, it can also be provided that the control element 32 is injected molded onto the fixing element in the plastics injection molding process.

The control element 32 configured as a wire or strip which is bendable spring-elastically is coupled to the fixing element 24 in such a manner that the control element 32 forms a continuation of the fixing element 24. Here, one end of the control element 32 forms a sensing portion 36 which interacts with the engagement component 21, as explained above.

Here, the control element 32 is configured in the manner of a leg spring which is designed for producing the prestressing of the fixing element 24 into the fixing state. The turns of the control element 32 configured as a leg spring are aligned here with the fixing element axis 24a, which leads to particularly good use of the construction space.

The control element 32 can be prestressed onto the engagement component 21, in particular onto the first control contour 27, wherein, in a refinement, the prestressing of the control element 32 is attributed to the spring elasticity of the control element 32 itself. In particular, in the exemplary embodiment shown in FIGS. 5 to 7, it is the case that the spring elasticity of the control element 32 also produces a prestressing of the fixing element 24 into the fixing state. Here, the control element 32 is configured for this purpose as a leg spring, as discussed above.

In addition, the spring elasticity of the control element 32 brings about prestressing of the control element 32 in the direction of the fixing element axis 24a, and therefore the control element is prestressed both in the radial direction and in the axial direction with respect to the fixing element axis 24a. In the present case, a particularly operationally reliable control of the movement of the control element 32 is therefore ensured by means of the first control contour 27 and the second control contour 33 without complicated spring constructions being required.

According to a further teaching, a motor vehicle lock 2 with an auxiliary locking drive 1 according to the proposal is disclosed. It can be the case here that, as indicated in FIG. 1, the motor vehicle lock 2 and the auxiliary locking drive 1 are assigned a common housing 37. As a result, the drive coupling between the second gearing element 14 and the lock latch 4 can be realized by means of a simple transmission element, for example by means of a transmission lever.

According to a further teaching which likewise obtains independent significance, a motor vehicle lock arrangement with a motor vehicle lock 2 and an auxiliary locking drive 1 is disclosed, wherein the motor vehicle lock 2 and the auxiliary locking drive 1 are configured separately from each other and are arranged separated spatially from each other. A remote force transmission means, here an above-discussed Bowden cable 17, can be provided here between the second gearing element 14 and the lock latch 4. Of advantage according to this further teaching is the fact that the motor vehicle lock 2, on the one hand, and the auxiliary locking drive 1, on the other hand, can be produced and fitted separately from each other.

In some embodiments, a method for operating an auxiliary locking drive 1 according to the disclosure, for operating a motor vehicle lock 2 according to the disclosure or for operating a motor vehicle lock arrangement according to the disclosure is disclosed.

It is essential, according to the further teaching that, within the scope of the auxiliary locking operation, after the auxiliary locking adjustment the fixing device 18 is released by means of the auxiliary locking drive motor 8, and therefore a subsequent, in particular spring-driven, reversing adjustment back into the starting state is decoupled from the auxiliary locking drive motor 8.

The method according to the proposal is decisively coordinated by means of the control arrangement 19. It is provided here, in a refinement, that the auxiliary locking adjustment is provided in a first adjustment direction, and the release adjustment in a second adjustment direction, opposed to the first adjustment direction, of the auxiliary locking drive motor 8. This is advantageous insofar as a certain relaxation of the auxiliary locking drive train is associated with the release adjustment, as has been explained further above.

It can be provided that the auxiliary locking drive motor 8 is adjusted in a time- or distance-controlled manner in order to release the fixing device 18. For a time-controlled adjustment of the auxiliary locking drive motor 8, the control arrangement 19 can be equipped with a timer which controls an energizing of the auxiliary locking drive motor 8 for a predetermined period of time. This is advantageous since a position sensor is not required for the auxiliary locking drive motor 8. Such a period of time may be between 10 ms and 1 s, such as 100 ms.

Alternatively, a distance-controlled adjustment of the auxiliary locking drive motor 8 can be provided. In the distance-controlled adjustment of the auxiliary locking drive motor 8, an incremental position sensor can be assigned to the auxiliary locking drive motor 8.

Especially in the two last-mentioned cases, it is provided that the auxiliary locking drive motor 8 is adjusted in a blocking-free manner in order to release the fixing device 18.

In respect of the further teachings, reference may be made to all of the embodiments regarding the auxiliary locking drive 1 according to the proposal.

1. An auxiliary locking drive for a motor vehicle lock comprising a lock latch and a pawl, the auxiliary locking drive, in the fitted state, providing an auxiliary locking drive train comprising an auxiliary locking drive motor and a planetary gearing which is connected downstream of the auxiliary locking drive motor and comprises a plurality of gearing elements, the gearing elements comprising a sun gear, a planet gear carrier and a ring gear,
wherein a first gearing element of the planetary gearing is coupled or is couplable to the auxiliary locking drive motor and a second gearing element of the planetary gearing is coupled or is couplable to the lock latch,
wherein, within the scope of an auxiliary locking operation, the lock latch is adjustable in the locking direction thereof by the auxiliary locking drive motor by the second gearing element performing an auxiliary locking adjustment from a starting state,
wherein a switchable fixing device is provided, with which, in order to produce and release a drive coupling between the first gearing element and the second gearing element, the in each case third gearing element of the planetary gearing is fixable and releasable, and
wherein the arrangement has been made in such a manner that, within the scope of the auxiliary locking operation after the auxiliary locking adjustment, the fixing device is released by the auxiliary locking drive motor, and therefore a subsequent, in particular spring-driven, reversing adjustment of the second gearing element back into the starting state has been decoupled from the auxiliary locking drive motor.

2. The auxiliary locking drive as claimed in claim 1, wherein, in the fitted state, the auxiliary locking adjustment of the auxiliary locking drive train brings about an adjustment of the lock latch in the locking direction thereof, in particular from a pre-locking position into a main locking position or into an overtravel position located on the other side of the main locking position.

3. The auxiliary locking drive as claimed in claim 1, further comprising a control arrangement which electrically activates the auxiliary locking drive motor within the scope of the auxiliary locking operation.

4. The auxiliary locking drive as claimed in claim 1, wherein the arrangement has been made in such a manner that the release of the fixing device is associated with a blocking-free adjustment of the auxiliary locking drive motor.

5. The auxiliary locking drive as claimed in claim 1, wherein the control arrangement adjusts the auxiliary locking drive motor in a time- or distance-controlled manner in order to release the fixing device.

6. The auxiliary locking drive as claimed in claim 1, wherein, after the release of the fixing device, the reversing adjustment takes place in a spring-driven manner.

7. The auxiliary locking drive as claimed in claim 1, wherein the auxiliary locking operation comprises a release adjustment of the second gearing element by the auxiliary locking drive motor, within the scope of which release adjustment an adjustable engagement component of the auxiliary locking drive train comes into engagement with the fixing device, releasing the latter.

8. The auxiliary locking drive as claimed in claim 7, wherein an intermediate gearing element which provides the engagement component is arranged in the auxiliary locking drive train between the auxiliary locking drive motor and the planetary gearing.

9. The auxiliary locking drive as claimed in claim 1, wherein the engagement component is adjusted in a blocking-free manner at least for the release adjustment of the second gearing element.

10. The auxiliary locking drive as claimed in claim 1, wherein the intermediate gearing element is configured to be endlessly adjusting in a blocking-free manner.

11. The auxiliary locking drive as claimed in claim 1, wherein the fixing device has a fixing element which fixing element is adjustable between a fixing state, in which said fixing element fixes the third gearing element, and a release state, in which said fixing element releases the third gearing element.

12. The auxiliary locking drive as claimed in claim 11, wherein the third gearing element has at least one latching formation with which the fixing element in the fixing state is in form-fitting engagement.

13. The auxiliary locking drive as claimed in claim 11, wherein the fixing element is configured as a wrap spring, and wherein the fixing element in the fixing state is in braking engagement with the third gearing element for the fixing of the third gearing element.

14. The auxiliary locking drive as claimed in claim 7, wherein the engagement component has a first control contour via which the fixing element is adjustable.

15. The auxiliary locking drive as claimed in claim 7, wherein a freewheeling mechanism is connected between the engagement component and the fixing element in such a manner that, in a first adjustment direction, the engagement component leaves the state of the fixing element unaffected, and, in a second adjustment direction opposed to the first adjustment direction, adjusts the fixing element into the release state.

16. The auxiliary locking drive as claimed in claim 15, wherein the freewheeling mechanism has a control element, in particular a control lever, which, in the first adjustment direction of the engagement component, is disengaged from the first control contour and, in the second adjustment direction, is in engagement or comes into engagement with the first control contour and which thereby adjusts the fixing element into the release state.

17. The auxiliary locking drive as claimed in claim 14, wherein the engagement component has a second control contour which controls the control element in the first adjustment direction of the engagement component in a manner disengaged from the first control contour.

18. The auxiliary locking drive as claimed in claim 1, wherein the engagement component is adjustable in a blocking-free manner in the first adjustment direction.

19. The auxiliary locking drive as claimed in claim 1, wherein the control element is configured as a wire or strip which is bendable spring-elastically and, for the release of the fixing arrangement, can be brought into engagement with the fixing arrangement.

20. The auxiliary locking drive as claimed in claim 1, wherein the control element is prestressed onto the engagement component.

21. A motor vehicle lock with an auxiliary locking drive as claimed in claim 1.

22. A motor vehicle lock arrangement with a motor vehicle lock and an auxiliary locking drive as claimed in claim 21, wherein the motor vehicle lock and the auxiliary locking drive are configured separately from each other and are arranged separated spatially from each other.

23. A method for operating an auxiliary locking drive as claimed in claim 1,
wherein,
within the scope of the auxiliary locking operation after the auxiliary locking adjustment, the fixing device is released by the auxiliary locking drive motor, and therefore a subsequent, in particular spring-driven, reversing adjustment of the second gearing element back into the starting state has been decoupled from the auxiliary locking drive motor.

24. The method as claimed in claim 23, wherein the auxiliary locking drive motor is adjusted in a time- or distance-controlled manner in order to release the fixing device.

25. The method as claimed in claim 23, wherein the auxiliary locking drive motor is adjusted in a blocking-free manner in order to release the fixing device.
